(19) United States
(12) Patent Application Publication
(10) Pub. No.: US 2014/0108478 A1
(43) Pub. Date: Apr. 17, 2014

(54) MAGNETIC TUNNEL JUNCTION BASED RANDOM NUMBER GENERATOR

(71) Applicant: QUALCOMM INCORPORATED, San Diego, CA (US)

(72) Inventors: Kangho Lee, San Diego, CA (US); Taehyun Kim, San Diego, CA (US); Xiaochun Zhu, San Diego, CA (US); David M. Jacobson, San Diego, CA (US); Raghu Sagar Madala, San Diego, CA (US); Wenqing Wu, San Diego, CA (US); Jung Pill Kim, San Diego, CA (US); Seung H. Kang, San Diego, CA (US)

(73) Assignee: QUALCOMM INCORPORATED, San Diego, CA (US)

(21) Appl. No.: 13/651,954

(22) Filed: Oct. 15, 2012

(51) Int. Cl. G06F 7/58

(52) U.S. Cl. 708/250

(57) ABSTRACT

A random number generator system that utilizes a magnetic tunnel junction (MTJ) that is controlled by an STT-MTJ entropy controller that determines whether to proceed with generating random numbers or not by monitoring the health of the MTJ-based random number generator is illustrated. If the health of the random number generation is above a threshold, the STT-MTJ entropy controller shuts down the MTJ-based random number generator and sends a message to a requesting chipset that a secure key generation is not possible. If the health of the random number generation is below a threshold, the entropy controller allows the MTJ-based random number generator to generate random numbers based on a specified algorithm, the output of which is post processed and used by a cryptographic-quality deterministic random bit generator to generate a security key for a requesting chipset.

### FIELD OF DISCLOSURE

The present disclosure relates to random number generators and more specifically to MTJ based random number generators that are monitored by STT-MTJ entropy controllers.

### BACKGROUND

Magnetic tunnel junctions (MTJ) consist of two layers of magnetic metals, such as cobalt-iron, separated by an ultrathin layer of insulator, conventionally aluminum oxide with a thickness of about 1 nm. The insulating layer is so thin that electrons can tunnel through the barrier if a bias voltage is applied between the two metal electrodes. In MTJs the tunneling current depends on the relative orientation of magnetizations of the two ferromagnetic layers, which can be changed by an applied magnetic field. This phenomenon is called tunneling magnetoresistance (TMR) which is a consequence of spin-dependent tunneling.

MTJs have many potential applications. One such application of MTJs is in Magnetic Random Access Memories (MRAM). The basic concept of MRAM is to use the magnetization direction in MTJs for information storage. “0” and “1” correspond to parallel and antiparallel magnetizations in an MTJ. The information bits can be written by passing a current through an MTJ, and they can also be read by measuring the resistance difference. MRAMs provide high density, non-volatile and low power consumption. The large TMR signal in MTJ also makes them attractive for magnetic media read heads and other types of sensor applications.

One example of MTJ use is in spin transfer torque (STT) MRAMs. An MTJ element for use as an STT MRAM has a configuration in which a tunnel barrier layer is sandwiched between two ferromagnetic layers. One of the ferromagnetic layers is a reference layer whose magnetization direction is fixed even when a current flows through the layer. The other ferromagnetic layer is a storage layer whose magnetization direction is variable when a current flows through the layer. The magnetization direction of the storage layer has two states. One state is correlated with a logical value “0” and the other state is correlated with a logical value “1”, thereby allowing the MTJ element to be used as a memory cell.

Data is written into the MTJ element by spin torque transfer magnetization switching. Specifically, the magnetization direction of the storage layer is reversed by a spin transfer torque which is generated due to a write current caused to flow through the MTJ element. Changing the direction of the write current allows the magnetization direction to be reversed to one of the two states of the storage layer.

The MTJ element has a resistance value that varies depending on the magnetization direction of the storage layer. Data is read from the MTJ element in the following manner. That is, a small read current, with which no magnetization switching occurs, is caused to flow through the MTJ element and the resistance value thereof is measured to be determined as a low resistance value or a high resistance value.

When a pulse (herein referred to as “random number generating pulse”) having an appropriately selected current value (herein referred to as “random number generating current”) between a write current value, which causes magnetization switching, and a read current value, which does not cause magnetization switching, is caused to flow through the MTJ element, the magnetization can be reversed with a magnetization switching probability larger than 0.0 and smaller than 1.0. In this regard, a technique may be devised in which a random number generating pulse, having a current value with a magnetization switching probability to the high resistance state between 0.0 and 1.0, is caused to flow through the MTJ element which is reset to the low resistance state in advance. Thus making it possible to randomly change the state of the MTJ element and to use the MTJ element as a random number generator.

As wireless technology becomes ever more prevalent, security has been an important issue in wireless communications. To generate secure keys for wireless communications, it is critical to have an entropy source based on ‘true’ random number generator. Currently, pseudo random number generators based on CMOS ring oscillators have been commonly used in wireless chipsets. However, these are inefficient and susceptible to external attacks because of the absence of ‘true’ random physical process. Thus it is desired to use MTJs that are fully compatible with STT-MRAM to generate random number outputs that are least susceptible to external attacks.

STT switching of magnetic tunnel junction devices is statistical in nature, i.e. dependent on switching probabilities of output data of 0 s and 1 s. Therefore switching voltage distribution may follow a Gaussian distribution in a certain range of write pulse width. In this sense, MTJ has a potential to be utilized as a true entropy generator. For any chips that use STT-MRAM technology, embodiments are disclosed to address how to produce random number output from a MTJ device that is exactly the same as the MTJs used in an STT-MRAM array without being dependent on a specific switching probability.

It is therefore desired to have an MTJ random number generator that uses a true entropy generator using STT-MRAM application. As such, one approach is to make a specialized MTJ that is optimized for memory applications. The proposed solution does not require MTJ switching probability to be close to 50%, hence operation of the proposed MTJ based random number generator becomes very simple. Therefore, fast and cost effective random number generator module can be implemented in any System on Chip (SOC) that employs STT-MRAM. The solution further proposes using same operating voltages as STT-MRAM and operation frequency is increased to achieve desirable switching probability. This simplifies the random number generator design while increasing the random number generator output bit rate. The operating voltages of the STT-MRAM will not change; instead, an approach is utilized to increase operation frequency to adjust the power level of the MTJ, which helps simplify the random number generator design and increase the random number generator's output bit rate.

### SUMMARY

Exemplary embodiments are directed to systems and methods for generating random numbers using MTJ devices. In one exemplary embodiment there is disclosed a system for generating random numbers using MTJ devices that includes an MTJ-based random number generator to generate raw random number data, an STT-MTJ entropy controller to monitor the MTJ element to ensure that the raw random number data is random, and an entropy distillation unit to process the raw random number data, wherein the entropy distillation unit processes the random number data if the entropy controller indicates that the raw random number data is random.

Other exemplary embodiments are concerned with a method for generating a random number using MTJ devices that includes generating raw random number data from an MTJ element, monitoring the MTJ element to ensure that the raw random number data is random, and post processing the raw random number data to generate the random number, if the monitoring indicates the raw random number data is in fact random.

### BRIEF DESCRIPTION OF THE DRAWINGS

The accompanying drawings are presented to aid in the description of the various embodiments and are provided solely for illustration of the embodiments and not limitation thereof.

FIG. 1 is a top block diagram of an MTJ-based Random Number Generator fully compatible with STT-MRAM

FIG. 2 is an illustration of one embodiment of an operational operation flow of an MTJ based random number generator.

FIG. 3 is an embodiment of one possible algorithm, set-reset pulsing algorithm as a way to generate random raw data.

FIG. 4 is an illustrative plot of the silicon data representation of the set-reset pulsing algorithm.

FIG. 5 is another embodiment of yet another possible algorithm, an alternating voltage pulsing algorithm, as a way to generate random raw data.

FIG. 6 is another embodiment of yet another possible algorithm, alternate state pulsing algorithm, as a way to generate random raw data.

### DETAILED DESCRIPTION

Aspects of the various embodiments are disclosed in the following description and related drawings directed to specific embodiments. Alternate embodiments may be devised without departing from the scope of the invention. Additionally, well-known elements will not be described in detail or will be omitted so as not to obscure the relevant details of the various disclosed embodiments.

The word “exemplary” is used herein to mean “serving as an example, instance, or illustration.” Any embodiment described herein as “exemplary” is not necessarily to be construed as preferred or advantageous over other embodiments. Likewise, the terms “embodiments”, “various embodiments” and “embodiments of the invention” do not require that all embodiments include the discussed feature, advantage or mode of operation.

The terminology used herein is for the purpose of describing particular embodiments and is not intended to be limiting of the various embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof. It will be further understood that deterministic random bit generators (DRGB) are one class of bit generators that use algorithms to generate bits. It will be further understood that an “algorithm” is a clearly specified mathematical process for computation; a set of rules, that, if allowed, will give a prescribed result.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

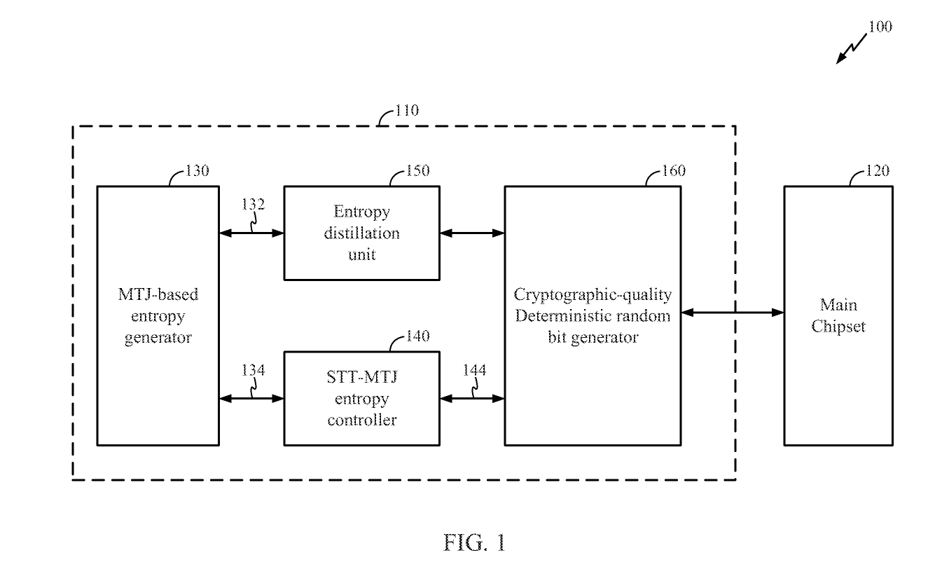

FIG. 1 demonstrates a top block diagram of random number generation system 100. System 100 may include two parts; MTJ-RNG block 110 and main chipset block 120. Within MTJ-RNG block 110 there is a raw random number generator (MTJ based entropy generator) 130, an STT-MTJ entropy controller 140 (may be a Hash DRBG 256 unit or the like), an entropy distillation unit 150 (may be CRC32 register unit or the like) that operates as an entropy distillation unit, and a cryptographic-quality deterministic random bit generator 160 which communicates with the main chipset block 120. In this embodiment, entropy may be defined as a measure of the disorder, randomness or variability in a closed system. Whenever the main chipset block 120 requests a security key from the cryptographic-quality deterministic random bit generator 160, cryptographic-quality deterministic random bit generator 160 may in turn probe MTJ based entropy generator 130 to generate the raw random number which may then be passed to the entropy distillation unit 150 to generate a more ideal data format that may be sent to the cryptographic-quality deterministic random bit generator 160 which may then be sent to the main chipset block 120 to make the proper secure connections.

A further view of FIG. 1 illustrates that for any chip that uses STT-MRAM technology, the proposed system and method produce random number outputs from an MTJ device that are exactly the same as the MTJs used in an STT-MRAM array. In other words, there is identical compatibility and dependency between producing the types of random number outputs and the MTJs used in an STT-MRAM array. Unlike prior technologies, one current embodiment does not require MTJ switching probabilities to be close to 50% and therefore the operation of the proposed MTJ based RNG becomes simpler, more cost effective and faster in terms of generation. Such a random number generator module can be implemented in any system-on-chip (SOC) that employs STT-MRAM.

A critical design consideration is to ensure that attackers cannot crack the RNG outputs by such methods as controlled magnetic fields. One example of an embodiment to ensure successful and secure random number generation is by designing an STT-MTJ entropy controller 140 that is specific to MTJ based entropy generator 130. For example, the STT-MTJ entropy controller 140 monitors RNG outputs and detects any forms of field attacks. In the presence of such risks, the STT-MTJ entropy controller 140 may decide to use a different method for number generation and relay that to the MTJ-based entropy generator 130 or STT-MTJ entropy controller 140 may shut down the MTJ-based entropy generator 130.

Another critical design consideration is to use the same operating voltages used in the STT-MRAM. This allows for operation frequencies to increase to achieve desirable switching probabilities while simplifying RNG design and increasing the RNG bit rate.

In one exemplary embodiment STT-MTJ entropy controller 140 may monitor the health of raw random number generator outputs and may also detect any potential risks such as system attacks and particularly magnetic field attacks. The STT-MTJ entropy controller 140 is an STT-MTJ entropy controller because when using MTJs as random number generators, there may need to be MTJ specific functions embedded in the controller to allow for proper communication between the controller and the MTJ based random number generator. In some situations, the STT-MTJ entropy controller 140 may manipulate the output of the random number generator to monitor the health and in other situations: STT-MTJ entropy controller 140 may shut down the MTJ-based entropy generator 130 entirely. In yet another embodiment, whenever main chipset block 120 needs a security key to make a secure connection, for example a wireless secure connection, the main chipset block 120 probes the cryptographic-quality deterministic random bit generator 160, which in turn may generate a random secure number. In such an event, the STT-MTJ entropy controller 140 may check the output health of the MTJ-based entropy generator 130. When the STT-MTJ entropy controller 140 determines that the output of the MTJ-based entropy generator 130 is deemed healthy, the MTJ-based entropy generator 130 is allowed to output generated random numbers to the entropy distillation unit 150.

In yet another embodiment, MTJ-based entropy generator 130 may have an input/output 132 to the entropy distillation unit 150 as well as an input/output 134 to the STT-MTG entropy controller 140 for monitoring the health of the MTJ output. In one embodiment, the STT-MTJ entropy controller 140 measures the soundness of the input/output 134 of the MTJ-based entropy generator 130. Soundness may include any of the following parameters but not limited to voltage bias and randomness of the raw data. If the health of the MTJ-based entropy generator 130 passes a certain threshold, then the MTJ-based entropy generator 130 outputs the random numbers generated to the entropy distillation unit via input/output 132.

If the STT-MTJ entropy controller 140 determines that the output does not pass a certain predetermined health threshold, then the STT-MTJ entropy controller may shut down the MTJ based random number generator through input/output 134. The shutting down process may then be relayed to the cryptographic-quality deterministic random bit generator 160 through input/output 144 and subsequently may be passed through the system back to the main chipset block 120 indicating that there is an error in the operation of the MTJ-based entropy generator 130. Such feedback may be construed as a feedback message indicating that the MTJ-based entropy generator 130 is shut down or is experiencing some form of an attack and a secured key may not be obtainable at that time. Considering the STT-MTJ entropy controller 140, it is worth noting that the design of the STT-MTJ entropy controller 140 may be dependent on the way the MTJ-based entropy generator 130 generates the raw data. Design parameters and considerations will be further discussed below.

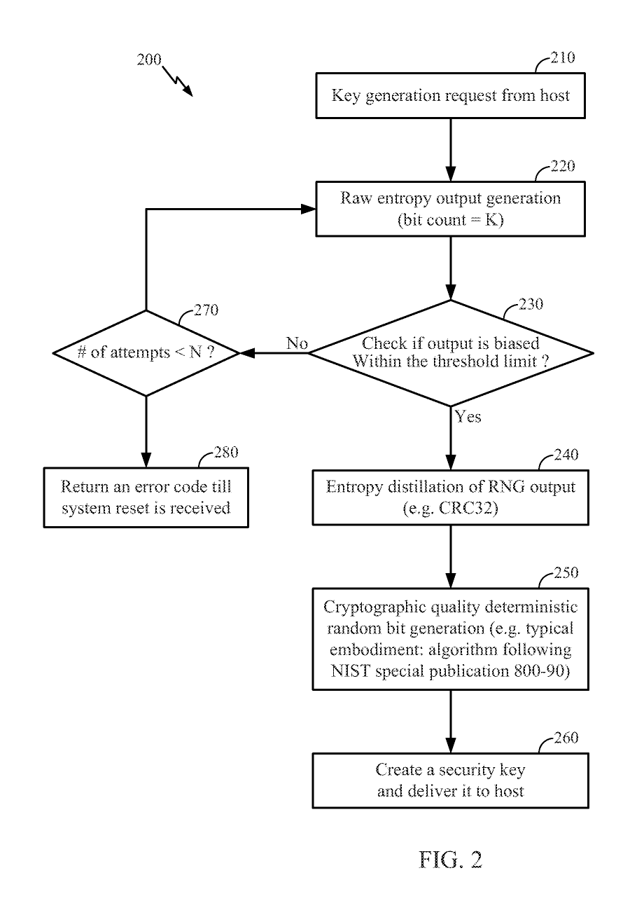

Looking at FIG. 2, there is shown an exemplary embodiment of an operation flow 200 of system 100. For example, a key generation request may be received, 210, from a main chipset block 120. After receiving a key generation request, a raw entropy output is generated, 220, which may contain a bit count equivalent to a selected number, such as K. In one embodiment, the value of the bit count “K” needs to be selected to provide sufficient random number bits to check statistical bias, e.g., 256 bits. It should also be mentioned that the output bits may have either a value of “1” or a value of “0”. The combination of bits may be used to generate numbers. After the first random number generator output is generated, the system checks if the output is biased within a threshold limit or outside it, 230, i.e. below or above the limit.

The threshold limit, for example may be set to include boundaries between 0.2-0.8, and a preferred range may be set as, for example, 0.4-0.6. The threshold limit may also be understood to be counting the bias of the data between “0”s and “1”s. It may be understood that a value that is chosen from a sample space is said to be biased if one value is more likely to be chosen than another value, i.e., more “1”s than “0”s. If the output is not biased within a given range, then the system 100 may cycle back again to generate a raw entropy output, 220.

If the number of attempts to cycle back to generate a first random number generator is greater than a value N, 270, then the system 100 may shut down by returning an error code until system reset is received, 280. This may be accomplished by shutting down the MTJ-based entropy generator 130 until a system reset is received from the STT-MTJ entropy controller 140. In other words, one of the methods to determine an error in the system, wherein the system is subject to external risk, is by determining a number N, wherein if the system continues to attempt to have an output that is biased beyond a certain threshold, then that is an indication that there may be external forces attempting to crack the RNG outputs. If the output is determined to be within the bias range, then the output of the MTJ-based entropy generator 130 is passed to entropy distillation unit 150 for entropy distillation, 240, by perfecting the randomness of the bits and/or uniformity of the random output. After distillation, entropy distillation unit 15 may pass the output to be post processed, 250, by the cryptographic quality deterministic random bit generator 160. Thereafter, cryptographic-quality deterministic random bit generator 160 may create a security key and deliver the security key to the main chipset block 120, 260. The operations of the cryptographic-quality deterministic random bit generator 160 are in accordance with those taught in National Institute of Standards and Technology (NIST Special Publication 800-90, “Recommendation for Random Number Generation Using Deterministic Random Bit Generators”, incorporated herein in its entirety).

In order to generate random numbers, the system utilizes special algorithms. The algorithms may be understood as clearly specified mathematical processes for computation or a set of rules that, if followed, will give a prescribed result. In other words, algorithms may be understood as methodologies used to extract raw random numbers from standard MTJ entropy generators that are used in STT-MRAM chips. As will be shown below, there are several algorithms that can be selected to generate random numbers. Different trends in the random number generation and output may be achieved using different algorithms. It is also important to note that algorithms need to be adapted not only for the MTJ-based entropy generator 130, but also for the STT-MTJ entropy controller 140. This allows having an entropy controller specific to an STT-MTJ, wherein the entropy controller monitors RNG outputs and detects any forms of filed attacks. In the presence of such risks, the use of the same algorithm is key to correctly detecting the biasing of the raw output data.

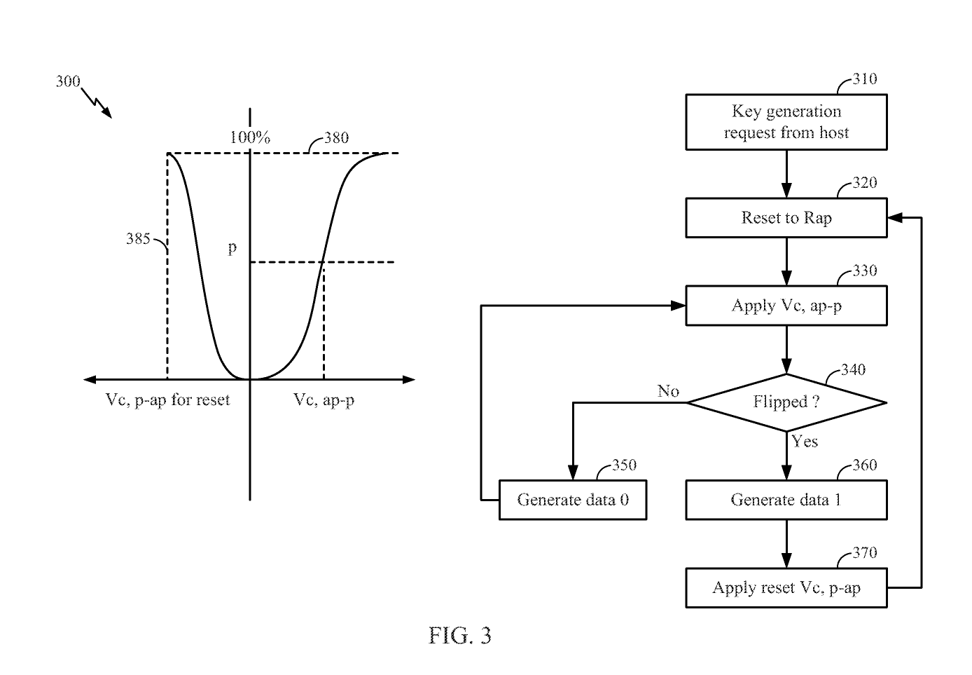

Looking at FIG. 3, there is shown a set-reset pulsing algorithm 300. Here, for example, a first type of algorithm, set-reset pulsing, utilizes the same switching voltage used for STT-MRAM operations. As can be seen, graph 380 represents a pulse width illustration curve for the MTG based entropy generator 130. In all cases, for each type of pulse width there may be a specific switching probability P represented as the P curve 380, wherein the x-axis may be set to represent the voltage Vc, p-ap and the y-axis may be set to represent the switching probability value, P.

In another embodiment, P curve 380 demonstrates that when the voltage increases switching probability also increases. In one embodiment, for example, when the voltage increases, the probability P may become a value that is very close to 100%. Conversely, when the voltage decreases, probability P decreases, which may yield a value that is very close to 0%. In yet another embodiment, utilizing different pulse width would yield a different switching probability distribution wherein voltage changes may more directly or less directly affect the change in the switching probability P. For example, when pulse width is decreased, the switching probability may be decreased, and the system may achieve a lower chance of switching success, wherein when the pulse width is increased, the switching probability may be increased, and the system may achieve a higher chance of switching success.

Looking at FIG. 3, one exemplary embodiment of the set-reset pulsing algorithm 300 may first allow the system to receive a key generation request from a host, 310. The algorithm 300 then resets to Rap 320 using a large negative voltage (p-ap), illustrated also by line 385 of P curve 380, and applies Vc, ap-p, 330. Algorithm 300 would then check whether the applied Vc, ap-p is flipped or not based on the switching probability, 340. If it is flipped, the system may generate digital data 1, 360, however if it is not, the system may generate digital data 0, 350, and in essence may apply the same voltage Vc, ap-p again. If the system generates digital data 1, 360, the system may then apply reset Vc, p-ap, 370, and reset to Rap, the original state of the system.

As stated above, algorithms may be understood as clearly specified mathematical processes for computation or a set of rules that, if followed, will give a prescribed result. In other words, algorithms may be understood as methodologies used to extract raw random numbers from standard MTJ entropy generators that are used in STT-MRAM chips. As such, algorithm 300 may be used to allow for the generation of a specific number of bits that contain specified entropy within a specified range of bias. This algorithm can help cryptographic quality deterministic random bit generator 160 to generate a key after receiving a 16 bit random number request. The generated key may be dependent on the generated number of bits from MTJ based entropy generator 130.

When the system uses a high Vc voltage for resets operations, this allows for better detection of reset operations, including failures. In this example, any failures in reset operations detected by the STT-MTJ entropy controller 140 can be detected because the high voltage reset creates predetermined states for the RNG resets. This would further allow the STT-MTJ entropy controller 140 to halt the security key generation process. Therefore, a detection of failures in reset operations may lead to a conclusion that there are external attacks on the system. For example, when the population of “1”s and “0”s are biased over the pre-defined threshold limit, the STT-MTJ entropy controller 140 stops the RNG operations and external field attacks can be avoided. It may be noted that external field attacks push the switching probability curve to the right or the left, depending on the strength of the external field. For example, a strong field may push the switching probability below or above a set threshold, further confirming the existence of an external attack.

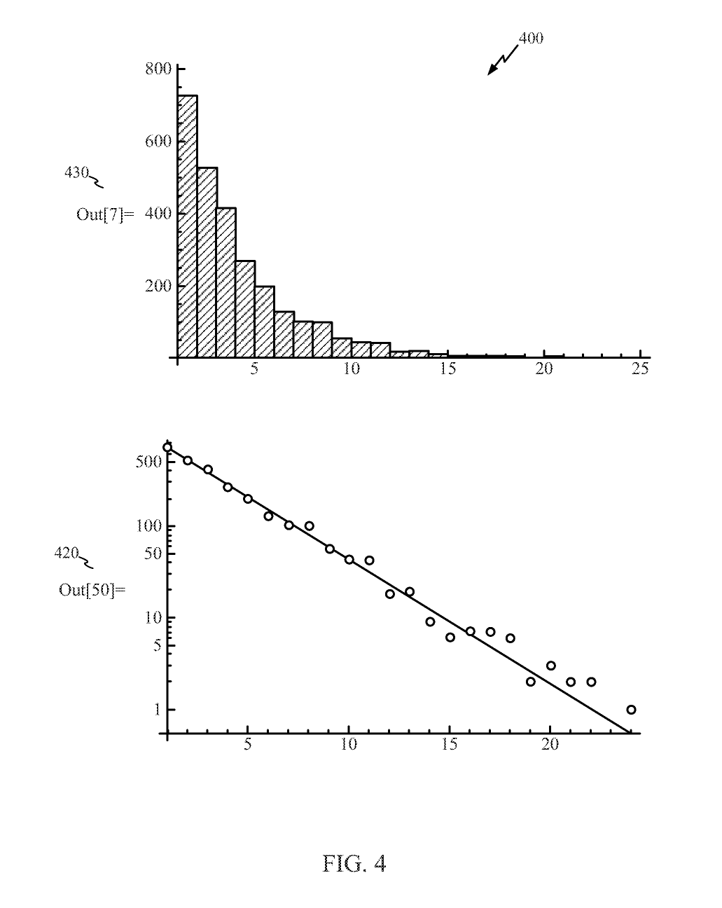

Referring to FIG. 4, an illustration of the silicone (Si) data 400 is shown. In one embodiment, plot 430 illustrates the randomness of the output data of algorithm 1. Here for example, the data randomness is measured by checking the distribution of the raw digital data plotted against x-axis values. This operation may be performed at the entropy distillation unit 150. In one embodiment, plot 430 may be illustrated using a selected switching probability of 30% which may yield a high level of randomness as illustrated in plot 420 as illustrated by the high correlation of the data points. A switching probability of 30% may indicate that the system may output more “0”s than “1”s, and more specifically, 70% “0”s and 30% “1”s.

Furthermore, plot 430 represents an exponential distribution of post processing for raw entropy data, and can further illustrate that even with a switching probability of 0.3 or 30%, the system can still generate a high level of randomness after post processing. Therefore, the level of security detection is proportionally related to the switching probability threshold range. For example, to establish more secure random number generation, a threshold range between 0.45 and 0.55 may be set, wherein anything below or above that range can signal a detected error or attack. To tie this approach to the security matter, the ideal randomness illustrated in plot 420 may yield an ideal security key that may not be cracked. Additionally, this analysis based on post processing data may show that MTJ can be used as a true entropy generator.

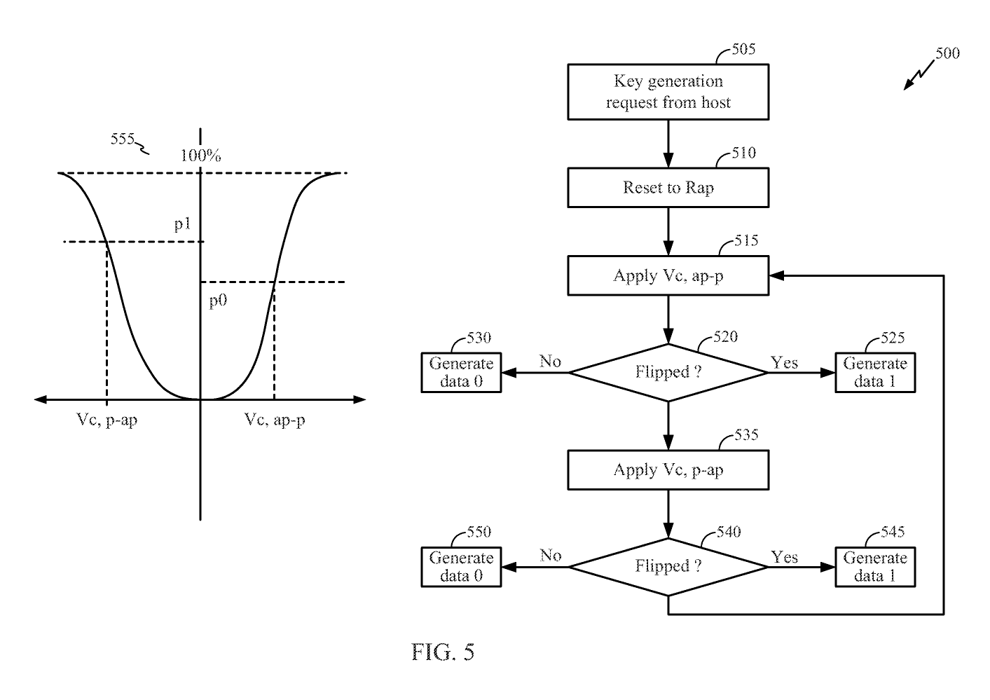

Referring to FIG. 5, a system 500 is shown for demonstrating an alternating voltage pulsing algorithm in accordance with another exemplary embodiment, i.e., alternating the switching event. Here, the primary objective of the algorithm may be to simplify the raw data bit generation and the detection of the switching failures. For example, the system 500 alternates the Vc voltage between p-ap and ap-p values and generate digital data 0 and digital data 1, accordingly. In one embodiment, system 500 receives a key generation request from the host main chipset block 120, 505. The system may then reset to Rap, 510, using large negative and positive voltages and applies Vc ap-p, 515.

The system 500 may then check whether the applied Vc, ap-p is flipped or not based on the switching probability, 520. If it is flipped, the system may generate digital data 1, 525, however if it is not, the system may generate digital data 0, 530. After applying a rest Vc, p-ap. 535, the system 500 may then determine whether the voltage is flipped or not, 540. If the voltage is flipped, then the system may generate a digital data 1, 545, however if it is not flipped, a digital data 0 is generated, 550. In yet another embodiment, irrespective of what digital data bit is generated, the alternating voltage pulsing algorithm system 500 may then loop back and repeat the step of applying Vc, ap-p, 515.

Unlike the set-reset pulsing algorithm of FIG. 3, wherein applying reset Vc, p-ap is dependent on the system 300 generating a digital data 1, here, the alternating voltage pulsing algorithm shown in FIG. 5 applies a reset Vc, p-ap, 535, irrespective of what data bit it generates in the previous step. It is also important to note that switching failures in this example generate a double zero “00” as opposed to a single ‘0’. This occurs for example when the system is originally in ap state. Applying a Vc, ap-p, 515, will not flip the voltage and thus, the system will generate digital data 0, 530. Then, when the system applies a Vc, p-ap, 535, the voltage will not switch because it is already in the ap state and therefore another “0” will be generated. This reset failure detection results in a detection method for external attacks. For example, if “00” is not output, then this indicates that the MTJ-based entropy generator 130 may be thermally unstable because of external field or thermal attacks.

Looking at probability curve 555, it can be understood that switching probabilities p1 and p0 may be selected dependent on the characteristics of the MTJ-based entropy generator 130. For example, every MTJ operates with different reactions to external factors such as changes in temperatures, and as such, the optimum switching probability may be selected based on those physical characteristics. In yet another example, increasing the temperature would make it easier to switch, therefore, when there is a fixed voltage supply, the increase in temperature would increase the switching probability.

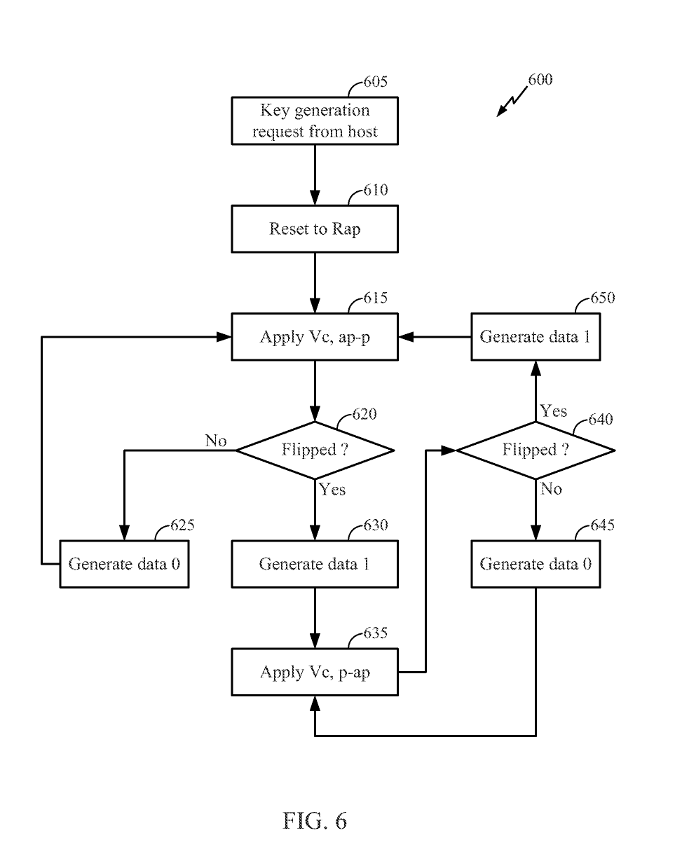

Looking at FIG. 6, there is shown a system 600 for demonstrating an alternating state pulsing algorithm in accordance with another exemplary embodiment. Here, the primary objective of the algorithm may be to alternate the state of the MTJ by applying either Vc, p-ap or Vc, ap-p. For example, the alternating state pulsing algorithm system 600 receives a key generation request from the host main chipset block 120, 605. The system may then reset to Rap, 610, using large negative and positive voltages and applies Vc ap-p, 615. The system 600 may then check whether the applied Vc, ap-p is flipped or not based on the switching probability, 620. If it is not flipped, the system may generate digital data bit 0, 625, and cycle back to the applying Vc, ap-p step, 615, of the process to repeat the cycle. If the voltage it is flipped, the system may generate digital data 1, 630. The system may then apply Vc, p-ap, 635, and check whether the voltage is flipped or not, 640. If the voltage is not flipped, then the system 600 generates a digital data bit 0, 645, and cycles back to the applying Vc, p-ap step, 635. If the voltage is flipped, then the system 600 generates digital data 1, 650, and cycles back to the applying Vc, ap-p step, 615.

In this algorithm, it can be appreciated that the number of consecutive “1”s and “0”s can be used to detect the bias. System 600 attempts to alternate states, and thus in the event that an external attempt is made to bias the switching probability, the system 600 will result in infinite loops that keep the system in the same state, i.e., ap or p. Again, as previous algorithms, when the population of “1”s and “0”s are biased over a pre-defined threshold limit, the STT-MTJ entropy controller 140 stops all RNG operations.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment can include a computer readable media embodying a method for generating random data. Accordingly, the various embodiments are not limited to illustrated examples and any means for performing the functionality described herein are included in the various embodiments.

While the foregoing disclosure shows illustrative embodiments, it should be noted that various changes and modifications could be made herein without departing from the scope of the invention as defined by the appended claims. The functions, steps and/or actions of the method claims in accordance with the embodiments described herein need not be performed in any particular order. Furthermore, although elements of the various embodiments may be described or claimed in the singular, the plural is contemplated unless limitation to the singular is explicitly stated.

The foregoing disclosed devices and methods are typically designed and are configured into GDSH and GERBER computer files, stored on a computer readable media. These files are in turn provided to fabrication handlers who fabricate devices based on these files. The resulting products are semiconductor wafers that are then cut into semiconductor die and packaged into a semiconductor chip. The chips are then employed in devices described above.

What is claimed is:

1. A method for generating a random number using MTJ devices comprising:
generating raw random number data from an MTJ element;
monitoring a switching probability of the MTJ element to ensure that the raw random number data is random; and
post processing the raw random number data to generate the random number, if the monitoring indicates the raw random number data is random.

2. The method of claim 1, wherein the switching probability of the MTJ element is less than 0.5.

3. The method of claim 1, wherein monitoring the MTJ element is performed by an STT-MTJ entropy controller configured to manipulate random number generation operations based on specific generation algorithms used by the MTJ element.

4. The method of claim 1, wherein the monitoring of the MTJ element is dependent on an algorithm used by the MTJ element to generate the raw random number data.

5. The method of claim 1, further comprising:
receiving a request for a security key; and
generating the security key based on the random number data.

6. The method of claim 1, wherein the monitoring further comprises:
checking an output of the MTJ element to determine if the output is biased above a threshold limit; and
if the bias is not above the threshold limit, generating a second set of raw random number data from the MTJ element, to be used as the raw random number data for the post processing.

7. The method of claim 6, wherein generating a second set of raw random number data further comprises:
resetting the MTJ element to a preset state;
applying a biasing voltage that is near a write threshold to the MTJ element; and
reading a value of the MTJ element.

8. The method of claim 7, further comprising:
wherein reading a value of the MTJ element, includes reading the MTJ element and detecting if a preset state has changed to an opposite state; and
resetting the MTJ element to the preset state, if the opposite state is detected.

9. The method of claim 7, wherein the preset state is one of either a parallel state or an anti-parallel state.

10. The method of claim 7, wherein the preset state is an anti-parallel state, and wherein the biasing voltage is an anti-parallel write threshold and further comprising:
applying a second biasing voltage that is near a parallel write threshold to the MTJ element; and
reading the value of the MTJ element.

11. The method of claim 10, comprising:
repeating the step of applying a biasing voltage that is near an anti-parallel write threshold to the MTJ element; and
reading the value of the MTJ element.

12. The method of claim 10, comprising:
if a value read represents the anti-parallel state, applying a biasing voltage near an anti-parallel write threshold to each MTJ in the MTJ element; and
if the value read represents the parallel state, applying the biasing voltage near a parallel write threshold to each MTJ in the MTJ element.

13. A system for generating random numbers using MTJ devices comprising:
an MTJ-based random number generator to generate raw random number data;
an STT-MTJ entropy controller to monitor an MTJ element to ensure that the raw random number data is random; and
an entropy distillation unit to process the raw random number data, wherein the entropy distillation unit processes the raw random number data if the STT-MTJ entropy controller indicates that the raw random number data is random.

14. The system of claim 13 further comprising:
a cryptographic-quality deterministic random bit generator to generate a security key based on the raw random number data and in response to a security key request from a chip.

15. The system of claim 13, wherein the STT-MTJ entropy controller is configured to control the MTJ-based random number generator based on specific algorithms run by the raw random number generator to generate raw data.

16. The system of claim 15, wherein the algorithms used by the MTJ-based random number generator are configured to output biased random numbers.

17. The system of claim 15, wherein the STT-MTJ entropy controller is further configured to detect a biasness level of the biased output random numbers in conjunction with the specific algorithms used to generate the raw data.

18. The system of claim 17, wherein the biasness level is detected within a set threshold limit set by the STT-MTJ entropy controller.

19. The system of claim 18, wherein the STT-MTJ entropy controller is configured to check the biased output random numbers of the MTJ element to determine if the MTJ element output is biased beyond the set threshold limit, wherein if the MTJ element output bias is not above the set threshold limit, the STT-MTJ entropy controller allows for continued random number generation.

20. The system of claim 19, wherein if the MTJ element output bias is above the set threshold limit, the STT-MTJ entropy controller will stop random number generation operations.

21. The system of claim 20, wherein when MTJ element output bias is above the set threshold limit, the STT-MTJ entropy controller detects an external attack and produces an error message to be sent back to a random number key requestor.

22. An apparatus for generating a random number using MTJ devices comprising:
means for generating raw random number data from an MTJ element;
means for monitoring a switching probability of the MTJ element to ensure that the raw random number data is random; and
means for post processing the raw random number data to generate the random number, if the monitoring indicates the raw random number data is random.

23. The apparatus of claim 22, wherein the switching probability of the MTJ element is less than 0.5.

24. The apparatus of claim 22, wherein the means for monitoring the MTJ element is performed by an STT-MTJ entropy controller configured to manipulate random number generation operations based on specific generation algorithms used by the MTJ element.

25. The apparatus of claim 22, wherein the means for monitoring of the MTJ element are dependent on an algorithm used by the MTJ element to generate the raw random number data.

26. The apparatus of claim 22, further comprising:
means for receiving a request for a security key; and
means for generating the security key based on the random number data.

27. The apparatus of claim 22, wherein the means for monitoring further comprises:
means for checking an output of the MTJ element to determine if the output is biased above a threshold limit; and
if the bias is not above the threshold limit, means for generating a new set of raw random number data from the MTJ element, to be used as the raw random number data for the post processing.

28. The apparatus of claim 27, wherein generating a new set of raw random number data further comprises:
means for resetting the MTJ element to a preset state;
means for applying a biasing voltage that is near a write threshold to the MTJ element; and
means for reading a value of the MTJ element.

29. The apparatus of claim 28, further comprising:
wherein the means for reading a value of the MTJ element, includes means for reading the MTJ element and means for detecting if a preset state has changed to an opposite state; and
means for resetting the MTJ element to the preset state, if the opposite state is detected.

30. The apparatus of claim 28, wherein the preset state is one of either a parallel state or an anti-parallel state.

31. The apparatus of claim 28, wherein the preset state is an anti-parallel state, and wherein the means for biasing voltage is an anti-parallel write threshold and further comprising: means for applying a second biasing voltage that is near a parallel write threshold to the MTJ element; and means for reading the value of the MTJ element.

32. The apparatus of claim 31, comprising: means for repeating the means for applying a biasing voltage that is near an anti-parallel write threshold to the MTJ element; and means for reading the value of the MTJ element.

33. The apparatus of claim 31, comprising:
if a value read represents the anti-parallel state, means for applying a biasing voltage near an anti-parallel write threshold to each MTJ in the MTJ element; and
if the value read represents the parallel state, means for applying the biasing voltage near a parallel write threshold to each MTJ in the MTJ element.

34. A method for generating a random number using MTJ devices comprising:
step for generating raw random number data from an MTJ element;
step for monitoring a switching probability of the MTJ element to ensure that the raw random number data is random; and
step for post processing the raw random number data to generate the random number, if the monitoring indicates the raw random number data is random.

35. The method of claim 34, wherein the switching probability of the MTJ element is less than 0.5.

36. The method of claim 34, wherein the step for monitoring the MTJ element are performed by an STT-MTJ entropy controller configured to manipulate random number generation operations based on specific generation algorithms used by the MTJ element.

37. The method of claim 34, wherein the step for monitoring of the MTJ element are dependent on an algorithm used by the MTJ element to generate the raw random number data.

38. The method of claim 34, further comprising:
step for receiving a request for a security key; and
step for generating the security key based on the random number data.

39. The method of claim 34, wherein the step for monitoring further comprises:
step for checking an output of the MTJ element to determine if the output is biased above a threshold limit; and
if the bias is not above the threshold limit, step for generating a new set of raw random number data from the MTJ element, to be used as the raw random number data for the post processing.

40. The method of claim 39, wherein generating a new set of raw random number data further comprises:
step for resetting the MTJ element to a preset state;
step for applying a biasing voltage that is near a write threshold to the MTJ element; and
step for reading a value of the MTJ element.

41. The method of claim 40, further comprising:
wherein the step for reading a value of the MTJ element, includes step for reading the MTJ element and step for detecting if a preset state has changed to an opposite state; and
step for resetting the MTJ element to the preset state, if the opposite state is detected.

42. The method of claim 40, wherein the preset state is one of either a parallel state or an anti-parallel state.

43. The method of claim 40, wherein the preset state is an anti-parallel state, and wherein the step for biasing voltage is an anti-parallel write threshold and further comprising: step for applying a second biasing voltage that is near a parallel write threshold to the MTJ element; and step for reading the value of the MTJ element.

44. The method of claim 43, comprising: repeating the step for applying a biasing voltage that is near an anti-parallel write threshold to the MTJ element; and step for reading the value of the MTJ element.

45. The method of claim 43, comprising:
if a value read represents the anti-parallel state, step for applying a biasing voltage near an anti-parallel write threshold to each MTJ in the MTJ element; and
if the value read represents the parallel state, step for applying the biasing voltage near a parallel write threshold to each MTJ in the MTJ element.

46. A non-transitory computer-readable storage medium storing computer-executable instructions for generating a random number, wherein executing the computer-executable instructions on a processor causes the processor to:
generate a raw random number data from an MTJ element;
monitor a switching probability of the MTJ element to ensure that the raw random number data is random; and
post process the raw random number data to generate the random number, if the monitoring indicates the raw random number data is random.
